(19) United States
(12) Patent Application Publication
(10) Pub. No.: US 2007/0151234 A1
(43) Pub. Date: Jul. 5, 2007

(54) Electricity produced by sustained air pressure

(76) Inventors: Charles Barnett Lampkin III, Oxford, MS (US); Beatrice Campbell Lampkin, Cincinnati, OH (US); Julia McCain Lampkin-Asam, Deltona, FL (US)

Correspondence Address: Charles Barnett Lampkin, III, M.S., 912 Chickasaw Road, Oxford, MS, 38655, US

(21) Appl. No.: 11/321,950

(22) Filed: Dec. 30, 2005

(51) Int. Cl. F16D 31/02

(52) U.S. Cl. 60/398

(57) ABSTRACT

Electricity is produced by sustained air pressure. There are three storage areas of compressed air which make this possible.

At the beginning, commercial air compressors are used to pump up storage area 2. To offset the inefficiency of the fuel that supply the compressors such as electricity, gasoline, natural gas or diesel fuel, one may take one to three days to pump up the storage area 1 and storage area 2. These two storage areas act as a skeletal system used with commercial compressors to pump up the storage area 3.

Pipes in storage area 1 and storage area 2 contain air at the pressures of 1 atm to 160 atm or 2,337.3 psi. Storage area 3 contains pressure air at the pressure of 3,000 psi, 3,500 psi, 10,000 psi, up to 30,000 psi. In addition heat of compression can be used to increase power.

### REFERENCES CITED

### U.S. Patent Documents

U.S. Pat. No. 4,265,599 May, 1981 Morton
U.S. Pat. No. 4,311,011 January, 1992 Lewis
U.S. Pat. No. 4,508,971 April, 1985 Bailey
U.S. Pat. No. 4,698,516 October, 1987 Thompson
U.S. Pat. No. 5,713,202 February, 1998 Johnson
U.S. Pat. No. 5,753,978 May, 1998 Lee
U.S. Pat. No. 5,771,693 June, 1998 Coney
U.S. Pat. No. 5,819,524 October, 1998 Bosley et al.
U.S. Pat. No. 5,901,899 May, 1999 Berkun
U.S. Pat. No. 5,934,063 August, 1999 Nakhamkin
U.S. Pat. No. 6,018,047 February, 2000 DeMarco et al.
U.S. Pat. No. 6,051,891 April, 2000 Surodin
U.S. Pat. No. 6,134,873 October, 2000 Nakhamkin
U.S. Pat. No. 6,079,197 June, 2000 Attin
U.S. Pat. No. 6,221,130 April, 2001 Koludzinj
U.S. Pat. No. 6,236,185 May, 2001 Hines et al.
U.S. Pat. No. 6,244,037 June, 2001 Nakhamkin
U.S. Pat. No. 6,247,221 June, 2001 Hansen
U.S. Pat. No. 6,249,057 June, 2001 Leher
U.S. Pat. No. 6,672,054 January, 2004 Merswolke et al.
U.S. Pat. No. 6,745,801 June, 2004 Cohen
U.S. Pat. No. 6,748,737 June, 2004 Lafferty
U.S. Pat. No. 6,759,266 August, 2004 Dodo et al.

### STATEMENT REGARDING FEDERALLY SPONSORED OR DEVELOPMENT

Not applicable.

### REFERENCE TO A “microfiche appendix”

Not applicable

### BACKGROUND OF INVENTION

This invention provides large volumes of compressed air which drive water turbines. The water turbines power generators produce electricity. This invention describes very large compressors unlike any other commercial compressed air compressors used today. 13,345 cu. ft. of atmospheric air or air at 1 atm is compressed each 30 sec. Technical field includes a unique type of compressor which produces electricity by the hydroelectric method.

### DESCRIPTION OF THE RELATED ART

Today, compressed air is not an efficient way to produce energy. Compressed air produced by electricity is less than 33% efficient. A steam plant is only approximately 40% efficient. Diesel powered compressors only have the efficiency of about 40%. Transmission of electricity over power lines lowers the efficiency also. In addition, some compressed air is lost at valve sites. For these reasons compressed air is not considered as an efficient way to produce electricity.

This invention provides a way that 200 Kw to 3,000,000 Kw electricity may be produced by sustained air pressure at one power company.

### DRAWING

FIG. 1 is a schematic drawing representing a hydroelectric process. Three compressor pipes 1, 2, and 3 are supplied by storage area 1.

Storage area 1 includes sixty 3 ft. diameter pipes containing air at the pressure of 1 atm, 20 psi and 80 atm. This includes 30 pipes for energy phase and 30 pipes for repair phase. Each of the sixty pipes is 1000 ft. in length.

There is a total of 496 2 ft. diameter pipes in storage area 2 which supply compressor pipe 2 and compressor pipe 3. These storage pipes contain air at the pressures of 10 atm, 20 atm, 40 atm, 80 atm, 120 atm, 140 atm, and 160 atm. All the pipes listed include both the energy and the repair phase. All pipes are 1000 ft. in length,

There is a 17 inch diameter surge pipe 4000 ft. in length. There is a 17 inch diameter air-hydropipe which is 4000 ft. in length located on a mound 15 ft. high. There is a water receiving tank located on a mound 30 ft. high which contains the water pushed through a water turbine.

There is a 17 inch diameter pipe 53 ft. in length which contains all the trapped atmospheric air in compressor pipes 1, 2, and 3. After compression of air at 1 atm, this 53 ft. pipe contains air at 160 atm or 2,337.3 psi.

### SUMMARY

The current method of using compressed air is an inefficient way to produce energy. Electricity is only about 33% efficient before it powers a compressor. Gasoline and diesel fuel are only about 40% efficient.

This invention describes how compressed air can be used to power a water turbine or push water through a water turbine with an energy efficiency of nearly 100%, making this invention a cost effective way of producing energy.

The compressed air puts pressure on top of the water and the valve is shut before any air is lost.

At the beginning, commercial compressors compress air to fill up pipes which are located in storage areas 1 and 2 at pressures of 1 atm, 20 psi, 10 atm, 20 atm, 40 atm, 80 atm, and 160 atm.

Air at 160 atm pushes through a water turbine which turns a generator which produces electricity. No compressed air is lost except at valve sites.

If air at the pressure of 80 atm can be stored 200 ft. underground in 16 ft. diameter pipes, compressed air can be a good source of energy as natural gas or oil. The depth of a 16 ft. diameter pipe would be determined by civil engineers.

When compressed air of 1000 psi to 1200 psi is supplied to natural gas turbines, it takes only one-third of the natural gas to bum to produce the same amount of heat energy or electricity as burning three times the volume of natural gas that burns in atmospheric air. 80 atm=14.7×80 minus 14.7=1161.3 psi.

Compressed air near 1200 psi aids in the combustion of natural gas.

It is important to explain that this invention includes production of electricity, hydrogen and compressed air for storage. Heat may also be produced.

One is limited to certain locations to drill for oil, to develop natural gas fields, or dig for coal on the surface of the ground.

However, compressed air in large pipes 16 ft. to 20 ft. in diameter surrounded by reinforced concrete above ground, 200 ft. underground, or as deep as 3,000 ft. can be used to provide air at the sustained pressures of 20 atm to 160 atm.

In addition, the equivalent of large volumes of air 190 atm, 5,000 psi, 10,000 psi, 30,000 psi to 40,000 psi may be stored in pressure vessels above ground or below ground.

### Methods To Insure Recycling

1. At the beginning, commercial compressors are used to supply compressed air to the storage areas 1 and 2. This process may take one to three days. By using commercial compressors at this time, the inefficiency of commercial compressors would be offset. A skeletal system of compressed air is created to pump up the storage areas 1 and 2 to contain air at the maximum pressures.

2. Using compressed air storage areas 1 and 2 to produce sustained compressed air by pushing water through the water turbines and saving all compressed air used, electricity can be produced in a continuous manner. Electricity produced by windmills or solar energy would aid in recycling of compressed air.

This process of recycling the compressed air at different pressures from 14.7 to 160 atm is a perfect marriage for using windmills or solar energy.

### THE DETAILED DESCRIPTION OF THE PREFERRED EMBODIMENTS

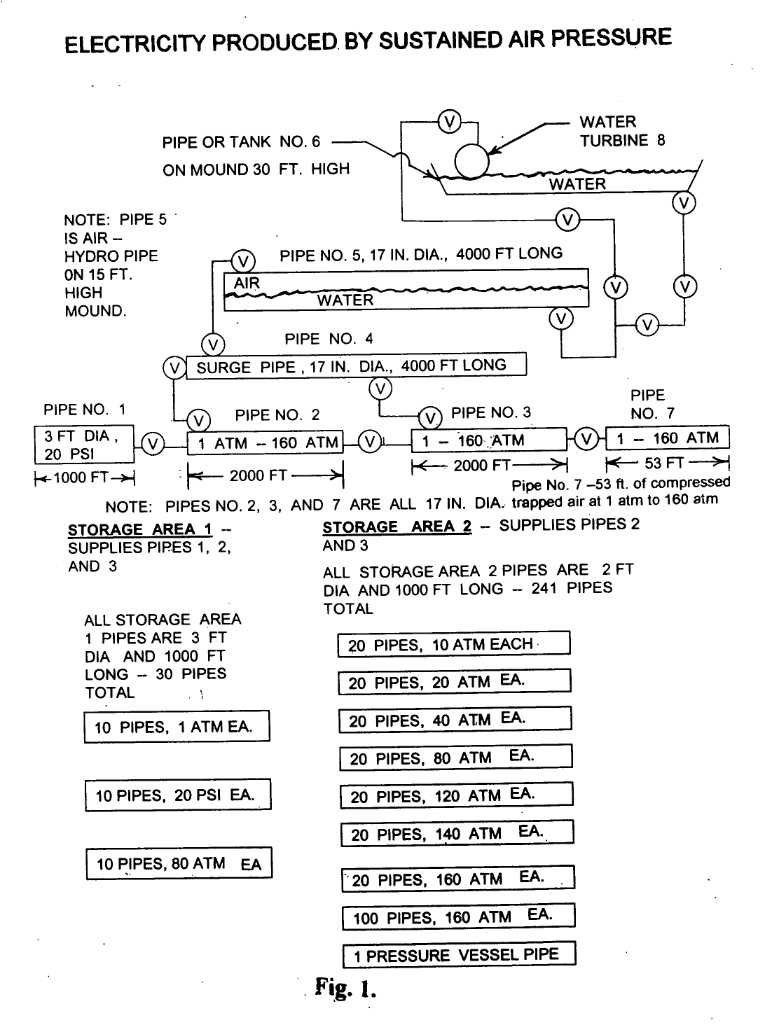

At the beginning of the hydroelectric process represented by FIG. 1 compressor pipe 1, compressor pipe 2, and compressor pipe 3 are all supplied by the ten 3 ft. diameter steel pipes located in storage area 1 containing air at the pressure of 20 psi or at least 14.7 psi. Storage area 1 also includes ten steel pipes at the pressure of 1 atm. In addition, there are ten 3 ft. diameter steel pipes in storage area 1 that contain air at a pressure of 80 atm. These pipes supply both the energy and repair phase.

After compressed air at 20 psi pushes into compressor pipe 1, compressor pipe 2, and compressor pipe 3, the valve is closed between compressor pipe 1 and compressor pipe 2. All valves are represented by the letter V. At this stage compressor pipe 1, 2, and 3 contain air at the pressure of at least 2 atm.

Compressed air at the pressures of 10 atm, 20 atm, 40 atm, 80 atm, 120 atm, 140 atm, and 160 atm from storage area 2 push into compressor pipe 2 and compressor pipe 3. In addition, 100 pipes located in storage area 2 containing air at the pressure of 160 atm, provide air at the sustained pressure of 160 atm to push the air at 160 atm into the surge pipe 4 and into the air-hydro-pipe 5 located on mound 15 ft. high or higher. There is no piston in the air-hydro-pipe 5 which is 17 inches in diameter and has a length of 4000 ft. Refer to FIG. 1.

Air at the sustained pressure of 160 atm pushes down on the water located in the air-hydro-pipe 5. The water is pushed through the water turbine 8 which is located above the water receiving tank 6 located on a mound 30 ft. high.

Electricity is produced when the water turbine 8 turns the generator.

No air is allowed to pass through the water turbine 8.

During the repair phase, the compressed air located in air-hydro-pipe 5 and compressor pipe 2 and 3 return to the storage areas at the descending pressures of 160 atm, 140 atm, 120 atm, 80 atm, 40 atm, 20 atm, and 10 atm, down to 20 psi down to 1 atm. Water and compressed air are recycled.

### Calculations

FIG. 1. Storage Area 2.

496 2 ft. diameter pipes×1,000 ft. each=496,000 ft.
496,000×$150 per ft.=$74,400,000 includes the energy phase and repair phase.

Storage Area 1
60 3 ft. diameter pipes×1,000 ft. each=60,000 ft.
60,000×$100 per ft.=$6,000,000 this includes both phases.
$74,400,000+$6.000.000=$80,400,000 cost of pipes in Storage Area 1 and in Storage Area 2.
496,000 ft. 2 ft. diameter pipes×3.14 cu. ft. per ft.=1,557,440 cu. ft.
60,000 ft. 3 ft. diameter pipes×7.065 cu. ft. per ft.=423,900 cu. ft.
1,557,440 cu. ft.+423,900 cu. ft.=1,981,340 cu. ft.
Calculate the power produced by 6,280 cu. ft. of water having the waterhead of 5,000 ft.
Each cycle takes 30 sec.
Power Equation; 209.33 cu. ft. per sec.×62.4 lbs per cu. ft.×5,000 ft. divided by 550 ft. lbs per sec.×0.746 Kw per hp=88,585 Kw
3,000,000. Kw plant divided by 88,585 Kw=33.865 units needed
141 plants each 3,000;000 Kw
141×33.865 units=4,775 units needed. 4,775×1,981,340 cu. ft.=9,460,898,500 cu. ft.=9.4608985×10⁹
2,900,000,000,000 cu. ft. Natural gas working volume in year 2001 according to DOE internet year 2001 divided by 9,460,898,500 cu. ft.=306.5 times less than natural gas working volume in year 2001.

$$\begin{matrix}\frac{2.9 \times {10}^{12}}{9.4608985} \times {10}^{9} \\ \frac{2.9 \times {10}^{12}}{.0094608985} \times {10}^{12}\end{matrix}$$

=306.5 times less than Natural Gas working volume to produce electricity consumed in one year. Therefore, this invention is efficient and cost effective.

1. A process for generating hydroelectric power by using a large compressor comprising steps of:
a) commercial compressors are used to pump up storage area 1 and storage area 2 to a level of compressed air which is called the skeletal system of compressed air of the said process claim 1;
b) storage area 1 of said process at the stage of the skeletal storage system of compressed air contain ten 3 ft. diameter pipes 1000 ft. in length which contain air at the pressure of 1 atm, ten 3 ft. diameter pipes 1000 ft. in length which contain air at the pressure at 20 psi, and ten 3 ft, diameter pipes 80 atm;
c) storage 1 contains a total of sixty 3 ft. diameter pipes 1000 ft. in length when the energy phase and repair phase are included;
d) storage area 2 of compressed air at the stage of the skeletal storage system of compressed air contains 20 2 ft. steel pipes 1000 ft. in length at the pressures of 10 atm, 20 atm, 40 atm, 80 atm, 120 atm, 140 atm, and 160 atm;
e) there are one hundred 2 ft. diameter pipes which contain air at the pressure of 160 atm;
f) there is one pressure tank for the energy phase and one pressure tank for the repair phase;
g) storage area 1 contains a total of 60 3 ft. diameter steel pipes and storage area 2 contains a total of 496 2 ft. diameter steel pipes;
h) storage area 1 supplies air at the pressure of 20 psi or at least 14.7 psi in compressor pipe 1, compressor pipe 2, and compressor pipe 3 of said process claim 1;
i) the valve between compressor pipe 1 and compressor pipe 2 is closed of said process claim 1;
j) compression in compressor pipe 2 and compressor pipe 3 is supplied by the skeletal area 2 at the pressures of 10 atm, 20 atm, 40 atm, 80 atm, 120 atm, 140, atm, 160 atm, plus, 100 2 ft. diameter pipes each 1000 ft. in length at the pressure of 160 atm of said process claim 1;
k) 100 2 ft. diameter steel pipes 1000 ft. in length containing air at the pressure of 160 atm supply air at the sustain pressure of 160 atm to the 17 inch diameter compressor pipe 2 and compressor pipe 3 each 2000 ft. in length;
l) air at the sustained of 160 atm pushes into surge pipe 4, 4000 ft. in length and then pushes into the top of air-hydro pipe 5 located on a mound 15 ft. high;
m) water in the air-hydro-pipe 5 is pushed down more than 15 ft. and then up to to the turbine 8;
n) water is pushed through turbine 8; which is located above a water receiving tank 6 located on a mound 30 ft. high of the process claim 1;
o) the turbine 8 turns the generator which produces electricity;
p) compressed air at the pressure of 160 atm at this stage occupies the air-hydro-pipe 5;
q) air in air-hydro-pipe 5 pushes into storage area 2 at the descending pressure of 160 atm, 140 atm, 120 atm, 80 atm, 40 atm, 20 atm, 10 atm, and into the storage area 1 at the pressure of 20 psi and down to 1 atm of atmospheric pressure;
r) at this stage air-hydro-pipe 5 again contains atmospheric air:
s) water flows down by gravity since the mound where the water receiving tank 6 is located 15 ft. higher than the air-hydro-pipe 5;
t) water now occupies air-hydro-pipe 5;
u) air occupies compressor pipe 2 and compressor pipe 3 after electricity is produced at the pressure of 160 atm;
v) air at the descending pressures pushes into storage area 2 at the descending pressures of 160 atm, 140 atm, 120 atm, 80 atm, 40 atm, 20 atm, 10 atm, and into storage area 1 at the pressure of 20 psi down to 1 atm or atmospheric pressure;
w) no air or water is allowed to escape when this method is used;
x) the repair phase is complete in said process claim 1;
y) recycling of compressed air and water is ready to take place;
z) heat of compression can increase power more than 50%.
